(19) United States
(12) Patent Application Publication
(10) Pub. No.: US 2009/0014075 A1
(43) Pub. Date: Jan. 15, 2009

(54) Dispenser Tap with Two Stage Valve

(75) Inventors: Guy Robert Hansson, Essex (GB); Paul Clifford Smith, Hertfordshire (GB); John Justin Walshe, Wiltshire (GB)

Correspondence Address: BROOKS KUSHMAN P.C., 1000 TOWN CENTER, TWENTY-SECOND FLOOR, SOUTHFIELD, MI, 48075, US

(73) Assignee: DIAGEO IRELAND, Dublin (IE)

(21) Appl. No.: 11/571,472

(22) PCT Filed: Jun. 30, 2005
(86) PCT No.: PCT/GB2005/002587

§ 371 Date: Sep. 13, 2007

(30) Foreign Application Priority Data
Jul. 2, 2004 (GB) 0414939.9

(51) Int. Cl. B67D 1/14

(52) U.S. Cl. 137/600

(57) ABSTRACT

A dispenser for delivering beverages (e.g. beer) including a main body (20), an inlet (21), an outlet (23) and a piston stop valve (23). In use, the piston moves from a first closed position (A) to a second position (B) where fluid is permitted only through restrictive channels (30) that causes turbulent flow and hence foam formation for the head of the beverage. In a third position (C), flow is completely open from the inlet to the outlet and foam formation is minimised.

### TECHNICAL FIELD

The present invention relates to a dispenser tap, particularly of the type used in public houses to dispense beer or ale products.

### BACKGROUND ART

FIG. 1 is a sketch of a common prior art dispensing tap that includes a main body 10 with inlet 11 and outlet 12 ports, the liquid flow therethrough being controlled by a piston-like stop valve 13. This kind of valve has been known for many years, usually operated by a pivoting lever and some type of spring loading acting to move the stop valve between a closed A and open B position.

Some beverage products (e.g stout) require the dispenser to include an agitating means to produce a foamy head as the beverage is dispensed. A usual way to achieve this is to use a creamer plate 14 (also known as a restrictor plate) that contains a plurality of fine holes 14a. Stout passes through the holes and gas (e.g. nitrogen) is encouraged out of solution to form tiny bubbles which comprise the head on the beverage.

A creamer plate 14 of the known type is simple and effective, however, it has several drawbacks. The main drawback is that over time the small holes 14a can become clogged with scale and other impurities from the beer delivery lines and from beverage that dries inside the dispensing nozzle outlet 12 when not in use.

Ideally, staff at the public house where the tap is installed will regularly clean the nozzle and creamer plate 14 by removal (the creamer plate is normally mounted in a threaded nozzle) and soaking overnight. Despite these relatively simple maintenance requirements, cleaning can be neglected and it is not uncommon for servicemen to be called out to fix a “faulty” dispenser, when all that is wrong is some scale built-up on the creamer plate.

Attempts have been made in the past to move the position of a conventional creamer plate to the “wet side” of the valve. For example, WO9837011 describes such an arrangement where all beer passing through the tap is agitated before it reaches the valve. This arrangement could be used with stout type beer but would still encounter clogging problems from impurities (it does, however, avoid the problem of dried beer deposits).

Also known to the hospitality trade is a dispenser tap more suitable for lager that does not include a creamer plate (because this would result in a glass full of foam and little or no actual liquid) in the main flow-line, but includes a secondary flow-line for a small portion of the liquid bound for the glass, that does include agitating means. This is simply an aid for the bar staff to deliver an aesthetically pleasing foam head to the lager. This is usually done by filling most of the glass with smoothly flowing liquid and then pressing a button on the tap to activate a brief squirt of agitated liquid through the secondary flow-line that provides a foamy head.

Such devices require some practice to use due to the timing of delivering a desirable head. Similar problems with cleaning of the extra flow channel agitating means can be experienced.

A prior art example that goes some way to providing an improved feature in dispenser taps is GB2225840. This construction includes a spiral groove in the end of the piston valve, with a seal upstream. A sloped side wall in the nozzle bore is such that when the seal lifts, beer flows into the grooves causing agitation until the valve withdraws fully, thereby allowing smooth flow. Careful control of the tap can allow the user to hold the dispenser in an agitated position to provide a foam head as desired.

GB2225840 has similar maintenance problems as described above, i.e the grooved end of the piston is in open air when not in use and thus can dry up and become clogged.

### DISCLOSURE OF THE INVENTION

It is an object of the present invention to provide an improved dispenser tap that goes some way to alleviating the problems experienced in the prior art or at least provide an alternative.

In one broad aspect the present invention provides a dispenser including a main body and a bore at least partially therethrough with an inlet, an outlet and a piston moving therewithin from a first position when, in use, fluid flow between the inlet and the outlet is closed to a second position where fluid flow is open toward the outlet, the open fluid flow being turbulent by moving though a channel formed in the main body or the piston upstream of the outlet where it was closed in the first position.

In one form of the invention the channel is a tunnel bored into the main body or piston.

In a preferred form of the invention a third position of the piston allows fluid flow to be “fully open” and not turbulent relative to the second position.

### BRIEF DESCRIPTION OF DRAWINGS

FIG. 1 is a two-stage view of a dispenser tap known from the prior art,

FIG. 2 is a three-stage view of a dispenser tap according to a first embodiment of the present invention with cross section and end views,

FIG. 3 is a three-stage view of a second embodiment,

FIG. 4 is a three-stage view of a third embodiment,

FIG. 5 is a three-stage view of a fourth embodiment,

FIG. 6 is a three-stage view of a fifth embodiment, and

FIG. 7 is a three-stage view of a sixth embodiment.

### MODE(S) FOR CARRYING OUT THE INVENTION

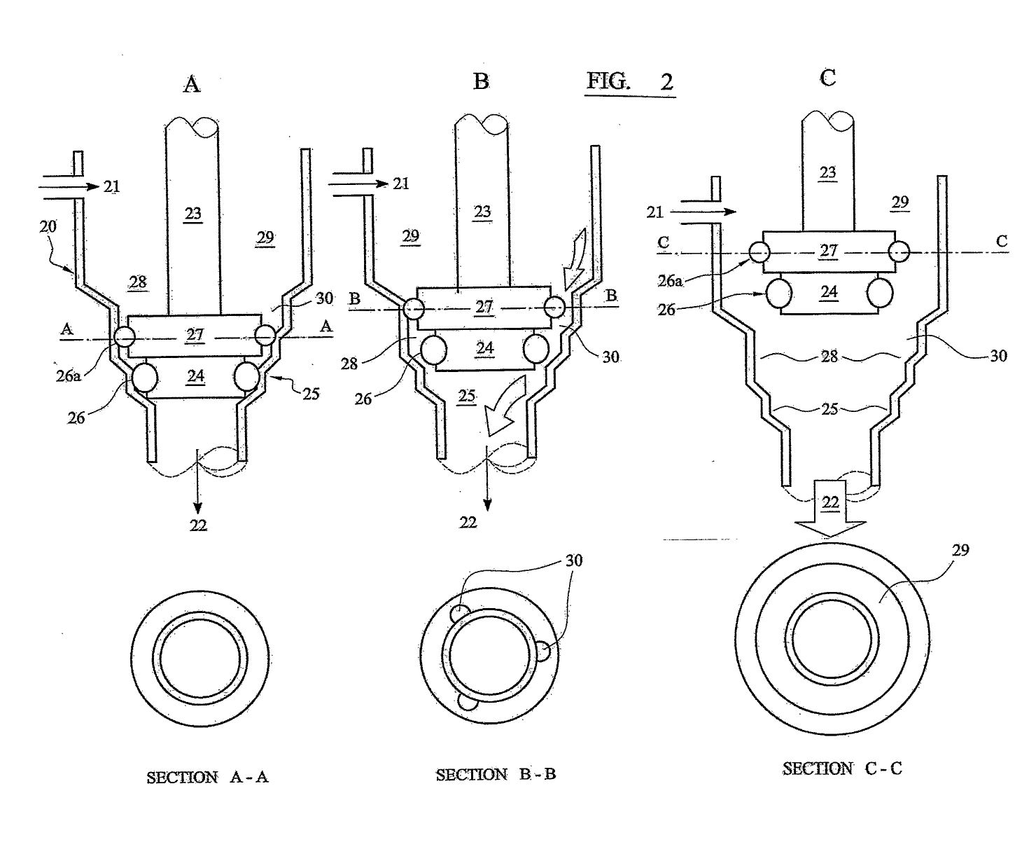

In FIGS. 2 to 5, three-stage operation of the dispenser tap according to the present invention will be shown by drawings denoted A (closed), B (intermediate or turbulent flow) and C (fully open flow). The common components of the present invention are a main body 20, an inlet 21, an outlet 22 and a piston valve member 23.

Referring to FIG. 2, the piston 23 can be seen to be in a closed position A where a piston head 24 sits in a widened diameter zone 25 relative to the bore of adjacent outlet nozzle 22. The piston 23 seals the outlet closed by virtue of an O-ring 26 surrounding the piston head 24 and against the wall of main body 20 at zone 25.

A second seal area is provided by a widened collar member 27 (wider than but adjacent to piston head 24) extending radially about the shaft of the piston 23. The second seal is an O-ring 26a around collar 27 and in contact with main body 20 at a second zone 28 of yet wider diameter than zone 25. Above zone 28 is a third zone 29 (referred to hereinafter) of yet wider bore diameter than zone 28. The subsequent zones provide a somewhat “stepped” appearance to the wall of main body 20 when viewed in cross section in the figures.

The end view section A-A shows the outlet for fluid through the dispenser completely closed.

Position B shows an intermediate stage where restricted (and hence turbulent) flow is allowed through the dispenser. Piston 23 is slightly withdrawn in position B.

Restricted flow is possible by virtue of a plurality of channels 30 formed longitudinally in the main body wall at zone 28, section B-B shows three evenly spaced semi-circular channels 30 or cut-outs where fluid can escape past collar 27 (with O-ring 26a). The size, shape and length of channels 30 can be varied (the size may be exaggerated in the drawing—in practice the channel will probably quite small) as appropriate to those skilled in the art. Generally the cross section area of the channels 30 would be only a fraction of the main bore diameters (e.g. less than 5%).

In position C the piston 23 is completely withdrawn into zone 29 that is substantially wider than collar 27. As such there is open and unrestricted flow through outlet 22. Section C-C shows the contrast of open flow to restricted flow through channels 30 shown in section B-B.

The intermediate flow stage B, through channels 30, replaces the creamer plate function known to the prior art. Moreover, this construction is completely flooded with fluid before and after use so there is no opportunity for beverage to dry and clog the agitating means (channels 30). Any debris within the system is adequately washed away when the dispenser is in the fully open position C.

It should be noted that piston head 24 with an O-ring seal 26 and zone 25 is not strictly necessary. In other words the “piston head” could be collar 27 alone, sealing within zone 28 in the closed position A. However, it is expected that over time channels 30 could wear away O-ring 26a and cause leakage. Therefore the piston head 24 as illustrated is provided because it operates at a different diameter to channels 30, avoiding wear.

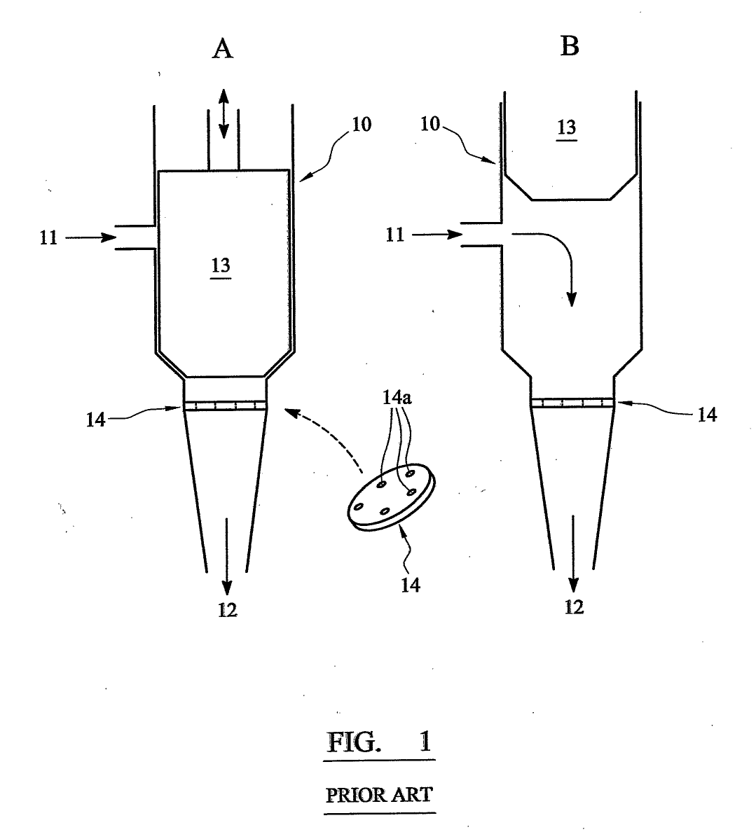

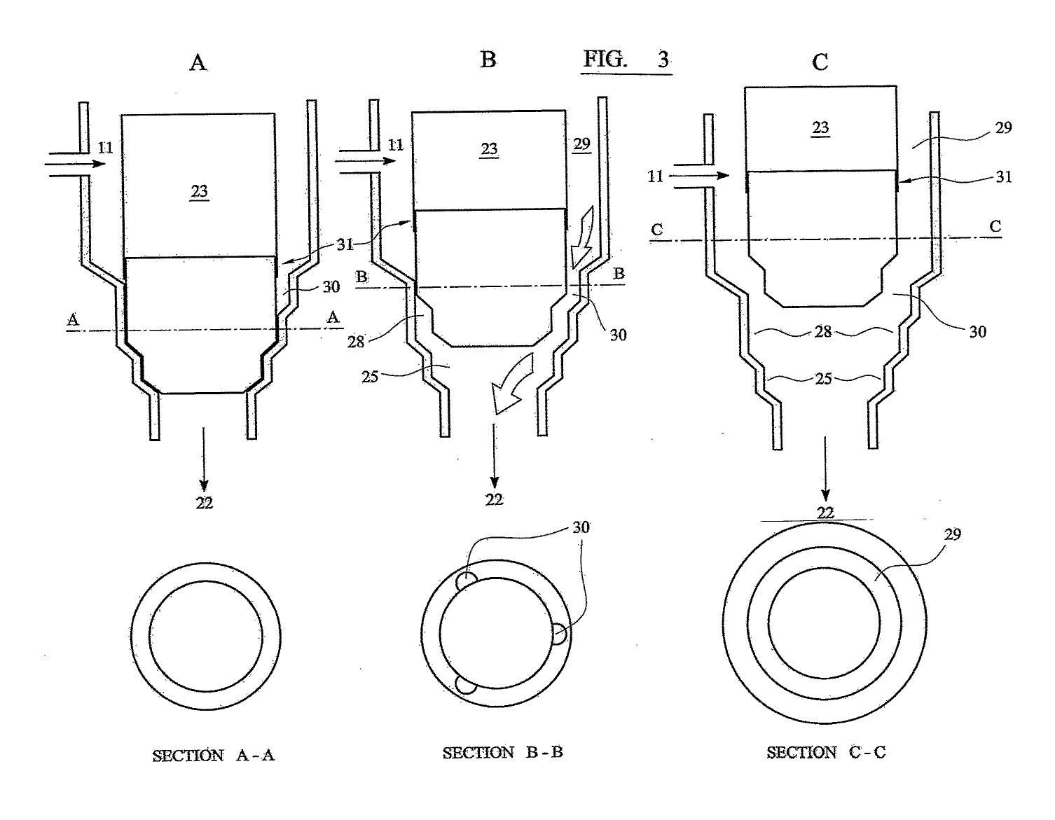

FIG. 3 illustrates a modified version of the concept from FIG. 2. In the place of “piston head” 24 and other parts of piston 23 is a moulded rubber boot 31 that includes several widened diameter step levels conforming to interference fit with and seal the zones 25, 28 and 29 of the main body. The rubber nature of boot 31 provides the seal with main body 20 without the need for O-rings. Section A-A in FIG. 1 shows the closed position.

When piston 23 begins to withdraw, flow through channels 30 is opened in position B (see end section view B-B). This is equivalent to the first embodiment of FIG. 2.

Position C is a fully open flow mode past the stepped zones of main body 20 toward outlet 22.

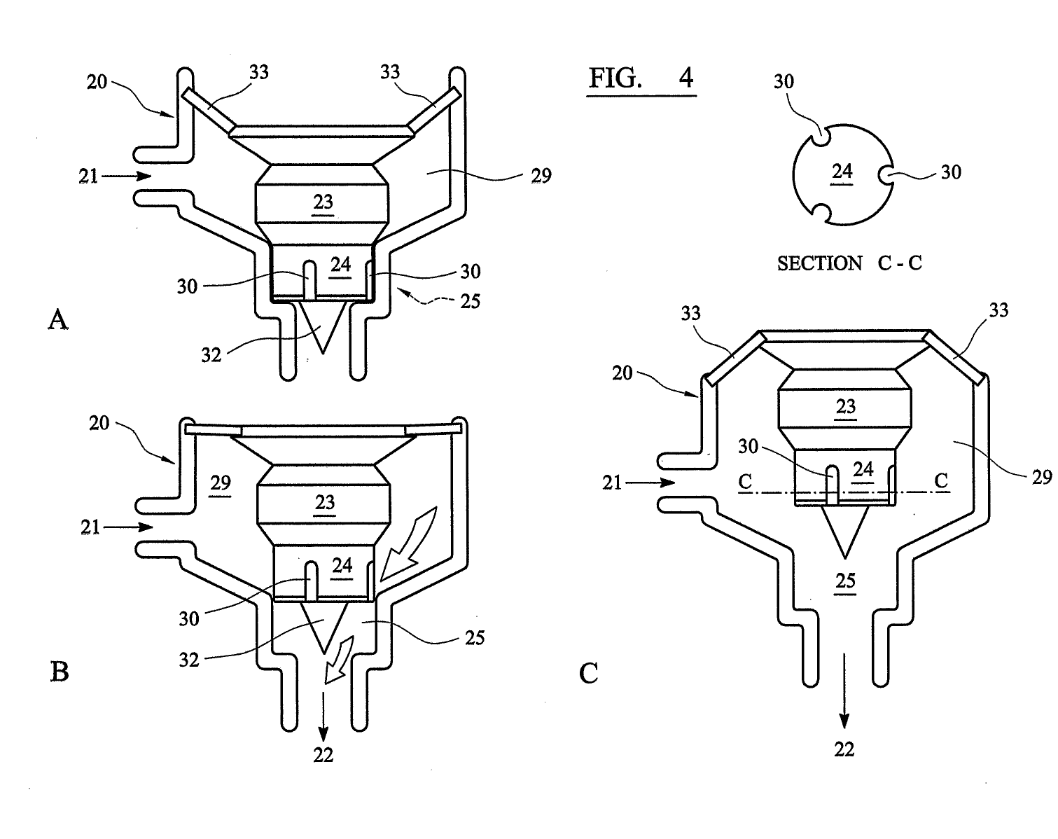

FIG. 4 illustrates a third embodiment with the same three-stage operation, but where the channels 30 are provided longitudinally in the wall of piston head 24 and not in the main body 20.

As can be seen in position A, the channels 30 extend from a lower-most edge of piston head 24 to a length terminating before zone 25 widens to zone 29 (there is no need for second zone 28 in FIG. 4). As such, turbulent flow begins when the piston 23 is withdrawn to a point where the channels 30 rise above zone 25 (position B). A conical end 32 on piston head 24 directs flow out of outlet 22.

Position C shows piston 23 withdrawn into zone 29 to open flow fully through the dispenser.

It will be apparent in FIG. 4 that a diaphragm 33 between an upper end of piston 24 and radially connected with the wall of main body 20 provides a seal to prevent the upper parts of the dispenser (where a lever or other control means would be located) being flooded and/or leaking.

The reverse movement (C-B-A) closes the valve, while first going through a turbulent phase B.

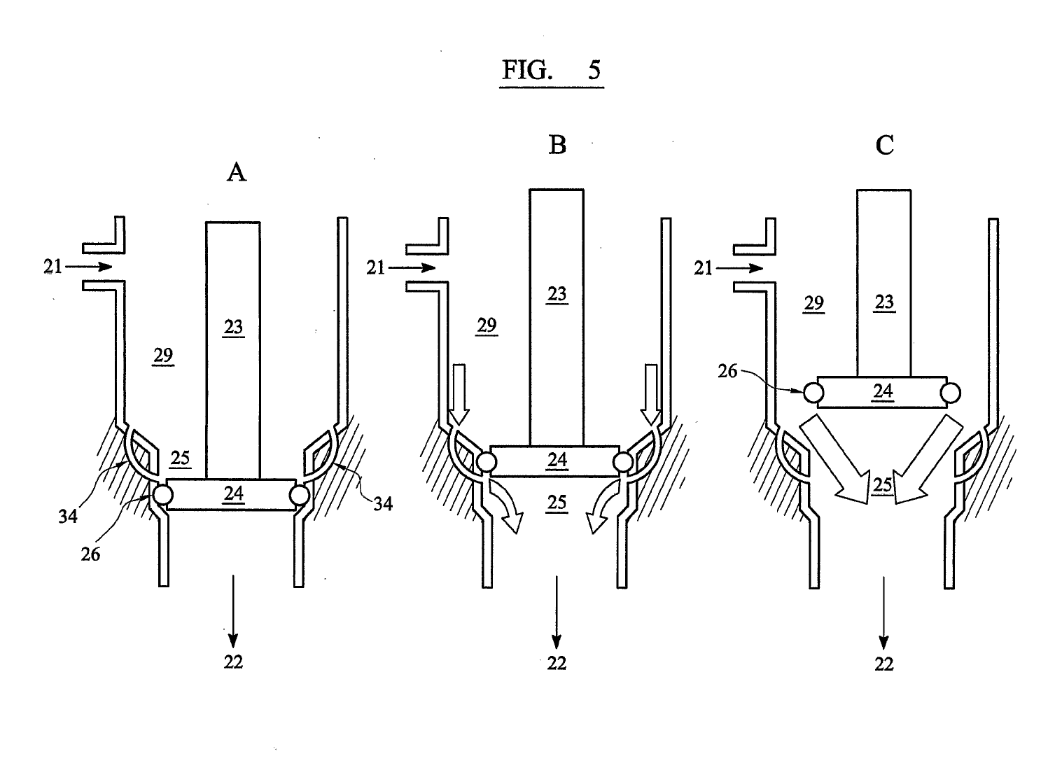

FIG. 5 illustrates an alternative embodiment where channels (or tunnels) 34 are drilled or otherwise formed to link zone 29 with a mid-point of zone 25 (again, there is no separate zone 28 as in FIGS. 2 and 3).

In position A piston head 24 (shown with an O-ring 26) is sealing outlet 22 by being situated below (downstream) the link tunnels 34. As the piston withdraws the dispenser enters turbulent flow mode by allowing fluid to force through the restricted tunnels 34 when the piston head moves beyond the outlet of link tunnel 34 (position B) in zone 25.

In position C the piston head 24 has withdrawn into zone 29 for fully open flow. The flow through tunnels 34 is negligible when in position C.

It can be noted that a smaller diameter zone could be included with a corresponding sealing member at the distal end of piston 23 (with an appearance similar to FIG. 2) such that any leak caused by wear on O-ring 26 moving past tunnels 34 will be eliminated. Furthermore, an equivalent operation could be obtained from tunnels formed in the piston, using additional zone 28 as previously.

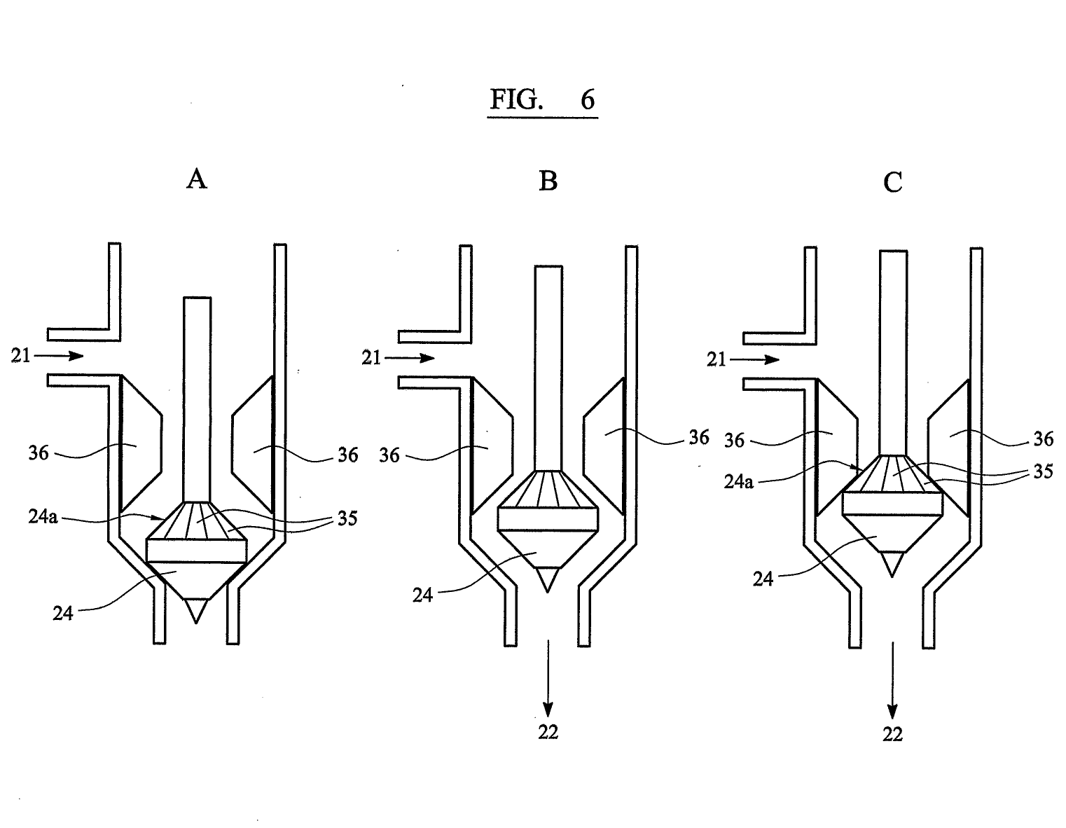

A fifth embodiment illustrated by FIG. 6 features channel means 35 formed in an upstream position on piston head 24 (by contrast to FIG. 4 and its more downstream channels 30).

As usual, position A is fully closed. The piston head 24 is angled in a conical shape with sealing properties against a corresponding sloped surface of main body 20 toward outlet 22. In this embodiment there are not strictly any stepped “zones” as in FIGS. 2 to 5.

As piston 23 withdraws, flow is opened to outlet 22. In this case flow at position B is fully open to deliver fluid.

As piston 23 continues to withdraw it contacts an annular insert 36 with a central bore passage that prevents further upward movement of piston head 24. Insert 36 is located around the tubular wall of main body 20 and may have conically inward-sloped walls to conform and seal with an upper surface of piston head 24. Insert 36 would close flow through the dispenser completely, however, channels 35 in the upper surface 24a of piston head 24 (contacting insert 36) provide the requisite gap and allow restricted flow and turbulence to create foam in the beverage.

Alternatively, the upper surface 24a of piston head 24 could be smooth and channels 35 can be formed in the downstream wall of the insert 36. This achieves the same result of a restricted flow path when piston head 24 is withdrawn to its maximum extent and stopped by insert 36.

The sequence of flow of this fifth embodiment: closed, full, turbulent is more suited to certain stout ale products where the longer period of pouring (position C) is desired to be turbulent. When pouring comes to an end (i.e. glass is full), the process reverses so there is a brief period of full flow before closure (C-B-A).

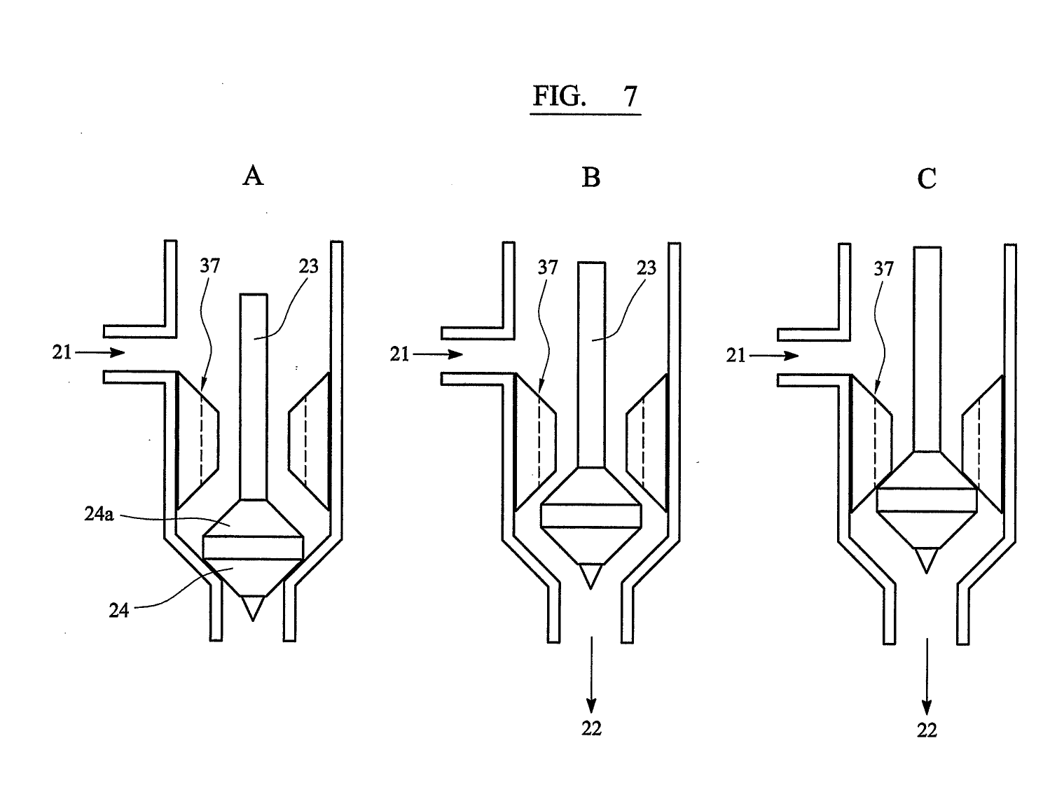

FIG. 7 is a variation on the embodiment of FIG. 6, except the piston head 24 does not include any agitating channels means. In the embodiment agitating means is provided by a channel or tunnel 37 through the insert 36.

Referring to position A, flow is closed as usual. Piston head 24 is sealed against outlet 22.

Position B is a fully open mode allowing fluid to pass smoothly toward the outlet 22.

As piston 23 withdraws it is stopped by insert 36 in the same way as FIG. 6. The sealing nature of piston head 24 against annular insert 36 would close flow completely, however, tunnels 37 permit restricted flow from the inlet portion 21 toward the outlet 22. The radial position of tunnels 37 in insert 36 must be wider than the radius of piston head 24 as illustrated, in order to ensure flow therethrough in position C.

As in FIG. 6, FIG. 7 is most suited for certain types of stout ale that require a creamy head.

Associated apparatus such as operating levers (to withdraw piston 23) have not been illustrated. A number of alternatives are possible, including electrical operating means to control withdrawal of the piston to specified dispensing presets.

Furthermore, it will be apparent to those skilled in the art that combinations and variations to the described concepts is possible, still within the scope of the present invention. For example, a ridge or protrusion from a wall of the piston could mate with a channel formed in the main body for additional sealing. This then opens the channel for turbulent flow only when the ridge of the piston withdraws sufficiently from the channel.

### INDUSTRIAL APPLICABILITY

The manufacturing and materials techniques to implement the present invention are well established in the art. Components may be machined from stainless steel or plastics as appropriate. Satisfactory tolerances and clearances for “must-fit” parts are important to ensure efficient working of the piston within the main body.

It is preferable but not essential that the restrictive portion of the design be made from a hard material like stainless steel as opposed to plastic for a durable sharp edge to be maintained.

1. A dispenser including a main body and a bore at least partially therethrough with an inlet, an outlet and a piston moving therewithin from a first position when, in use, fluid flow between the inlet and the outlet is closed to a second position where fluid flow is open toward the outlet, the open fluid flow being turbulent by moving though a channel formed in the main body or the piston upstream of the outlet where it was closed in the first position.

2. The dispenser of claim 1 wherein the main body bore includes at least two different diameter sections, the narrower diameter being formed toward the outlet.

3. The dispenser of claim 1 wherein the main body bore includes up to four different diameter sections, said diameters increasing from the outlet upstream toward the inlet.

4. The dispenser of claim 2 wherein the channel is of finite length and situated (e.g. by reference to the first position) within one diameter section of the bore, not extending to another.

5. The dispenser of claim 1 wherein the piston includes a piston head with means to seal adjacent the outlet in the first position.

6. The dispenser of claim 1 wherein the piston includes a collar with a radius extending to seal against the main body.

7. The dispenser of claim 1 wherein there are a plurality of channels extending longitudinally and spaced about the internal circumference of the main body.

8. The dispenser of claim 1 wherein there are a plurality of channels extending longitudinally and spaced about the circumference of the piston.

9. The dispenser of claim 1 wherein the channel is a tunnel.

10. The dispenser of claim 1 including a third position where the piston is in a widened part of the bore allowing open fluid flow between the inlet and the outlet.

11. The dispenser of claim 1 including a diaphragm extending radially from the piston to the main body.

12. The dispenser of claim 1 wherein the bore includes a midsection of narrowed diameter, a piston head of wider diameter—than the narrowed mid-section, there being channels formed in the piston head.

13. The dispenser of claim 1 wherein the bore includes a midsection of narrowed diameter, a piston head of wider diameter than the narrowed mid-section, there being channels (or tunnels) formed in the mid-section to a radius wider than the piston head.

14. The dispenser of claim 12 wherein the mid-section is an insert.

15. A dispenser including a main body with an inlet, an outlet and a piston, therebeing channels formed in the main body or the piston upstream of a sealing means associated with the piston adjacent the outlet.
